(19) United States
(12) Patent Application Publication
(10) Pub. No.: US 2011/0041713 A1
(43) Pub. Date: Feb. 24, 2011

(54) CONTACT OR TRANSFER ROLLER

(75) Inventors: Andreas Haakmann, Belm (DE); Thomas Rosemann, Bissendorf (DE); Achim Siebert, Bissendorf (DE); Joerg Tellenbroeker, Spenge (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: WEROS TECHNOLOGY GMBH, Melle (DE)

(21) Appl. No.: 12/809,148

(22) PCT Filed: Dec. 22, 2008
(86) PCT No.: PCT/DE08/02112

§ 371 Date: Sep. 7, 2010

(30) Foreign Application Priority Data
Dec. 21, 2007 (DE) 10 2007 062 940.2

(51) Int. Cl. B41F 7/02

(52) U.S. Cl. 101/217

(57) ABSTRACT

A distributor or transfer roller is provided for printing machines, in particular for offset printing machines. The roller has at least a substantially rigid core and a cover made of a polymeric material applied on and permanently fixed to the core. The cover is applied directly on the core or on a hard-elastic intermediate layer having a hardness of ≧10 Shore D, optionally by an adhesion promoting layer. The cover is at least substantially made of a fluorinated polymer and has a hardness of ≧15 Shore D and/or a scratch hardness according to ISO 15184 of 6B or harder. The polymeric material can be a duroplastic material, a fluorinated polyurethane resin, polyester resin, epoxy resin, acrylate resin and/or polyether resin, a highly cross-linked non-elastic fluoropolymer, a fluorothermoplastic, a polymeric non-elastic fluorosilicone, or a fluoropolymer lacquer.

### CROSS-REFERENCE TO RELATED APPLICATIONS

This application is a Section 371 of International Application No. PCT/DE2008/002112, filed Dec. 22, 2008, which was published in the German language on Jul. 2, 2009, under International Publication No. WO 2009/080003 A1 and the disclosure of which is incorporated herein by reference.

### BACKGROUND OF THE INVENTION

This invention relates to a distributor or transfer roller for a printing machine, in particular for an offset printing machine, the roller having a substantially rigid core and a cover made of polymeric material, which is applied on and permanently fixed to the core, the cover being directly applied on the core or on a hard-elastic intermediate layer having a hardness of ≧10 Shore D, if necessary by means of an adhesion-promoting layer. The invention also relates to a printing machine including a distributor or transfer roller according to the invention.

Inking units of printing machines serve to transfer the printing medium or the printing ink from a reservoir to a printing plate, from which the image to be produced is mostly transferred to a rubber blanket cylinder and from there to the material to be printed, such as a paper layer for example. The inking unit consists of a plurality of different counteracting roller pairs forming a roller nip between them. Transfer rollers having an elastomeric coating applied on the roller core form a first roller type. A second roller type is formed by distributor or hard transfer rollers, in which the cover made of polymer material is directly applied to the roller core that mostly consists of a metallic material or to a hard-elastic intermediate layer having a hardness higher than 10 Shore D. During the operation of the inking unit, the distributor rollers perform a traversing movement in the roller longitudinal direction, in order to homogenize the ink film in the roller nip by this movement and in cooperation with a soft-elastically coated distributor roller. Transfer rollers of the above-mentioned second type do not perform such a traversing movement. Transfer rollers of the first type mostly counteract one or more of the distributor or hard transfer rollers of the second type within the inking unit.

Important for the operation of the inking unit and for an optimal homogenization of the printing medium, the occurrence of inhomogeneities of the printing medium film, such as cording effects etc., and a printing image which is as optimal as possible, is the respective counteraction of roller pairs whose elastic properties are precisely matched with each other. In view of the very high rotation speeds and the mutually matched hardness of the counteracting rollers, the dynamic properties of the rollers are particularly important in this context. But also the hydrophilic or hydrophobic surface properties of the rollers are important. On the other hand, particularly high demands must be made on distributor rollers and hard transfer rollers of the second type, concerning the abrasion behavior and mechanical stability. For these reasons, distributor rollers or hard transfer rollers are mostly used which have hard rubber or Rilsan covers. The above-mentioned requirements are thus met by a design of the inking unit with the above-mentioned first and second type of rollers whose respective function in the inking unit is fundamentally different.

Rollers of the first type have already been optimized in a versatile manner with regard to their surface properties and especially also with regard to their print image, ink transfer within the inking unit, etc. To this end, the use of fluorinated polyolefins comprising elastomeric materials has been proposed on various occasions.

Nevertheless, there is a continued need for improving the ink transfer in the printing unit toward obtaining an optimum print image, making the printing process less susceptible to faults, minimizing corrective actions during the printing process, and particularly also further improving the emulsification behavior of the printing medium in printing machines that use an inking unit in combination with at least one dampening unit.

Furthermore, from European Patent EP 942 833 B1 a roller for color processing is known, which comprises a coating made of polymeric material or reactive resin and with a layer thickness which is considerably smaller than 500 μm. In particular, the coating can consist of duromeric phenolic resin or polyurethane resin. This ensures a good heat transfer from the printing medium to the roller core. Despite the fact that the roller surface exhibits a certain oleophilicity, the above-mentioned problems cannot be solved by using such rollers.

### BRIEF SUMMARY OF THE INVENTION

The present invention is based on the object of providing an inking unit or rollers to be employed in this inking unit and solving the above-mentioned problems. This object is achieved by a roller for printing machines, in particular offset printing machines, the roller having a substantially rigid core and a permanently fixed cover made of polymeric material applied on the core, the cover being directly applied on the core or on a hard-elastic intermediate layer having a hardness of ≧10 Shore D, characterized in that the cover comprises at least predominantly or substantially fluorinated polymers and that the cover has a hardness of ≧15 Shore D or a scratch hardness according to ISO 15184 of 6B or harder or both. The object is further achieved by an inking unit or a printing unit comprising at least one such roller, the roller being designed as a distributor roller or hard transfer roller.

Surprisingly, by the use of rollers according to the invention, an improvement of the print image and also of the transfer of the printing medium within the printing unit could be observed, which also clearly reduces irregularities in the printing process and allows the machine to run more smoothly. This is particularly true if the rollers of the invention counteract soft-elastic transfer rollers that have a strongly hydrophobic surface, e.g. with a cover which, concerning the polymeric material, mainly or substantially fully consists of fluoropolymers or fluoroelastomers as known from German patent document DE 10 2004 054 425. This is attributed to the fact that the distribution or homogenization of the fluid printing medium in the roller nip is substantially facilitated by the fact that the counteracting rollers exhibit similar surface energies and that strongly hydrophobic rollers (e.g. soft-elastic transfer rollers) no longer counteract more hydrophilic rollers like Rilsan or hard rubber distributors. Matching the surface energies of the two rollers with each other at the roller nip, surprisingly improves the homogenization and also the printing medium transfer in the printing unit to a considerable extent. This reduces interventions into the printing process and allows an increase in the printing speed and an improved formation of the fluid film.

The hardness of the near-surface fluoropolymeric cover can amount to ≧20-25 Shore D or ≧30-35 Shore D. Preferably, the hardness of the cover is in a range of 25-90 Shore D, e.g. in a range of 30-80 Shore D and particularly preferably in a range of 30 or 40 to 60 or 70 Shore D.

Alternatively or simultaneously, the object is achieved by a roller as described above whose near-surface fluoropolymeric cover exhibits a scratch hardness according to ISO 15184:1998(E) of 6B or even harder, preferably a scratch hardness of 5B to 4B or harder, for example a scratch hardness of 2B to B or harder. In particular, the scratch hardness can also be F to H or harder, for example ≧2H or ≧3H or ≧4H. The scratch hardness is determined by a hardness test according to Wolff-Willborn. Accordingly, for each of the hardness values that have been stated, a roller cover is available which does not yet show any scratch marks in a scratch test using a specified pencil according to ISO 154184. The specified pencil hardness accordingly corresponds to the hardest pencil that does not yet leave a corresponding discernible scratch mark. But the respective scratch mark can be visible or palpable. The respective scratch that is produced can be a plastic deformation of the roller cover (if the scratching is even more severe, the scratch may destroy material and can be produced while destroying the cohesion of the roller material (cohesive fracture)), i.e. under cracking of the material. The cracks can possibly extend as far as to the substrate. Like the scratch hardness, also the Shore hardness depends on the cohesive power of the material, although both physical parameters do not directly correlate with each other.

Accordingly, the near-surface cohesive power of the cover is determined by the scratch hardness of the cover. In this connection, it has been shown that for achieving the object, distributor or transfer rollers comprising a cover surface having a defined cohesive power which corresponds to a scratch hardness of 6B or higher are particularly expedient for surprisingly achieving the inventive improvement of the homogenization and the transfer of the printing medium in the inking unit.

Preferably, the fluorinated polymer is a duroplastic or energy-elastic material.

The fluoropolymeric cover of the roller of the invention can thus be “non-” or “virtually non”-elastic. Hence it is fundamentally different from conventional elastomeric covers. The expression “non-elastic” may be understood here in terms of “not entropy-elastic” or “not rubber-like or soft-elastic.” Accordingly, the cover may possibly exhibit “energy elasticity.” Based on a T (temperature) versus log E (elastic modulus) diagram (xy plot), the energy-elastic zone is at temperatures below the glass transition and the entropy-elastic zone is at temperatures above the glass transition. If there are more glass transition temperatures, the glass transition shall be the one which is closest to room temperature and among these especially that glass transition whose transition temperature is higher than room temperature. In particular, the cover material can be so selected that the glass transition temperature is above room temperature and/or above the working temperature of the roller cover. The glass transition temperature (defined if necessary by the turning point) can be ≧20-30° C., ≧40-50° C. or ≧60-70° C. or if necessary also ≧80-90° C. Accordingly, at the temperatures of 20-30° C., 40-50° C., 60-70° C. and/or if necessary also 80-90° C., the fluoropolymeric cover can be energy-elastic. The glass transition temperature can be lower than ≦250-300° C. or ≦175-200° C., it can also be ≦125-150° C. or ≦250-300° C. It can generally be below or also above the decomposition temperature of the polymeric coating material. In particular, the upper limit of the glass transition temperature can also be ≦30-50° C. or approximately room temperature (22° C.). If an intermediate layer made of polymeric material is provided between the fluoropolymeric cover and the roller core (the layer is thus different from the adhesion-promoting layer), this layer can be “hard-elastic” or “energy-elastic” and hence different from the conventional soft-elastic (“entropy-elastic”) intermediate layers, equally at the operating conditions of the roller or at room temperature or at temperatures of 20-30° C., 40-50° C., 60-70° C. or if necessary also 80-90° C. The elastic modulus of the polymeric (hard-elastic) intermediate layer at room temperature, at 30° C., at 50° C., at 70° C. and/or at the operating temperature of the roller can be higher than that of the fluoropolymeric near-surface cover.

It will be understood that the cover can be preferably directly applied on the hard-elastic intermediate layer, preferably using an adhesion-promoting layer.

The roller can have a surface roughness (i.e., average depth of roughness Rz determined according to DIN EN ISO 4287) of ≦17-20 μm Rz, preferably ≦12-15 μm or ≦7-10 μm, particularly preferably ≦4-5 μm or ≦2-3 μm or ≦1 μm.

Accordingly, the surface energy of the roller of the invention or that of the roller cover that can provide the roller surface, preferably amounts to ≦25 mN/m, particularly preferably ≦22-23 mN/m or ≦20-21 mN/m, so that no water is adapted directly from the roller surface. Thus, the emulsion becomes generally more arid. This is an important advantage over the materials as employed to date in such thin-coated rollers. Although these coatings served to make the roller surface hydrophobic to make the same absorb ink instead of water, the roller surface apparently still adapted water to a relevant extent. This is also true for Rilsan-coated rollers. As has been shown within the scope of the invention, this is probably the reason for process instabilities that can be removed by using the rollers of the invention, which do not adapt any more water.

Furthermore, it has been surprisingly noticed that depositions of silicon aggregates on the rollers of the invention can be considerably reduced. The reason for the development of such silicon-containing aggregates resulting in instable and faulty emulsions of the printing medium, is unclear in the end. The development of the silicon aggregates depends in a complicated manner on the printing media that are used and also on the materials that are to be printed, e.g. the paper grades. At the same time, even the development of such silicon aggregates on the soft-elastic transfer rollers counteracting the rollers of the invention is reduced, which suggests a certain “vaccination behavior.” Furthermore, by using the rollers of the invention, even depositions of calcium aggregates on the roller surface can be surprisingly reduced to a considerable extent. The reduction of the deposition of such silicon aggregates can partly take place independently of the reduction of similarly undesired depositions like calcium aggregates, and vice versa. Under certain printing conditions, depositions of even both silicon and calcium aggregates on the roller surfaces can be prevented by the rollers according to the invention. These silicon and calcium depositions can occur jointly and also independently of each other. The reasons for these depositions are not yet understood. The advantages of the rollers of the invention are observed especially in rollers having coatings made of duromeric material, such as highly cross-linked fluorinated polyurethane resins, epoxy resins, polyester resins, polyether resins and/or acrylate resins. In a similar way, these advantages are observed when the cover contains highly cross-linked, non-elastic materials containing as monomers fluorovinyl ether or fluoroalkylvinyl ether, in particular perfluorovinyl ether or perfluoromethylvinyl ether or mixed halogenated monomers, like chlorine-fluorine-substituted olefins like chlorotrifluoroethylene, or only partially halogenated monomers, like hydropentafluoropropylene, and also for high-polymeric compounds containing or comprised of tetrapolymers having a fluorine content of >67% by weight, for example up to 60% by weight fluorine, in relation to the weight of the polymers.

Accordingly, the inventive inking unit rollers having a low surface tension no longer retain salt (e.g. calcium and/or silicon aggregates) on the surface. They do not allow hydrophilization and provide for a permanently arid (“dry”) stable emulsion. Dampening water is thus prevented from returning from the printing plate into the inking unit, where it is normally undesired and may lead to deficient emulsions (ink or oil in water emulsion). Compared thereto, conventional rollers carry water and salts along into the inking unit. After the evaporation of the water, the salts (e.g. calcium aggregates) become deposited on rollers having a relatively high surface tension and increase in this way the surface tension of the wetted rollers, hydrophilize the surfaces and thus increase the water balance and need of the inking unit, which may finally lead to a deficient emulsion and to a breakdown of the ink transfer.

Moreover, the rollers of the invention further optimize the emulsification behavior of the printing medium in connection with the employed dampening unit and further minimize the water consumption in the inking unit.

Furthermore, the distributor or transfer rollers of the invention surprisingly facilitate the overall cleaning of the printing or inking unit to a considerable extent, even if soft-elastic transfer rollers having strongly hydrophobic covers with, for example, a high fluorine content are already employed within the inking unit. This is attributed to the fact that, compared to conventional distributor rollers, the printing medium or the washing medium contaminated by the printing medium no longer stays or even accumulates on the distributor roller, so that the printing medium, due to the very low surface tension, can be very quickly removed, even from the hard distributor or transfer roller and thus completely from the printing unit.

The cover preferably provides the roller surface, or is provided if necessary, with a thin surface coating, which preferably has no considerable influence on the surface hardness of the cover and which may have a layer thickness of ≦7-10 μm, ≦3-5 μm or ≦1-2 μm. The cover which exhibits a hardness of ≧15 Shore D can thus also consist of a material which is different for the possibly provided elastic (hard-elastic or energy-elastic) intermediate layer. In particular, it may consist of a different base material or different polymers of the base material. The cover which is arranged closest to the surface of the roller can normally have a higher hardness than the elastic intermediate layer. The elastic intermediate layer can consist, for instance, of hard rubber whose fluorine content is considerably lower than that of the cover, namely preferably <50%, <25% or <5-10% of that of the cover. Advantageously, the intermediate layer is free from fluorine or halogen. The intermediate layer can particularly have a lower hardness than the cover, but if necessary also an approximately equal or even higher hardness. The cover that is used in each case is homogeneous throughout its layer thickness and/or axial extension, in particular with regard to its composition and/or its physical properties, e.g. the hardness and/or the fluorine content. But there can be of course provided fillers, additives and other components, which are preferably homogeneously distributed in the cover and which preferably do not cause any gradients of the composition and/or of the physical properties throughout the layer thickness of the cover. The cover can be respectively connected to the elastic intermediate layer or to the core by an adhesion-promoting layer.

Preferably, the cover consists for its major part or at least substantially of fluorinated polymeric material which can be present at a moiety of ≧50, ≧75-80, ≧90, ≧95 or ≧98% by weight or at least approx. 100% by weight, in relation the total weight of the cover. Other polymer moieties can be non-elastic components, for example, if necessary with a different hardness or different properties.

In a particularly preferred embodiment, the fluorinated polymer of the cover is a duroplastic material, i.e. the material is present as a thermally irreversible or covalently cross-linked macro molecule having an amorphous structure and a high degree of crosslink density. Preferably, the polymer moiety having the thermo-elastic properties at room temperature and/or the region or polymer moiety subject to thermo-elastic softening at usual conditions or at conditions just allowing the operation of the roller, is virtually negligible or not present.

Preferably, the thermosetting polymer exhibits a high degree of crosslinking, e.g. in relation to a decomposition of the polymer basic structure in monomer units, e.g. in units of monomers having a C atomic number of ≦C4-C6 or ≦C7 or ≦C8 monomer units, ≧10-15 or ≧20-25, preferably ≧30-40 crosslink points for each 100 monomers, the crosslinking points preferably being irreversible or covalent. It will be understood that the monomer units can represent the monomers as identified by retrosynthesis, while the duroplastic polymers can be produced as usual by polymerization of a plurality of monomer-containing oligomers.

It turns out to be particularly beneficial, if the duroplastic polymers include one or more polymers selected from the group consisting of polyurethane resins, polyester resins, epoxy resins, polyether resins, polycarbonate resins and acrylate resins. Despite the presence of the functional urethane, ester, epoxy, ether, carbonate or acrylate groups, such duroplastics are strongly hydrophobic, which is due to a sufficiently high fluorine content, and they exhibit a very low tendency of depositing silicon aggregates and also a low tendency toward adhesion of the printing medium. If necessary, these materials can also include thermoplastic moieties.

In a further preferred embodiment, the fluorinated polymer of the cover can be a non-elastic highly cross-linked polymer, for instance a copolymer (including ter- or tetrapolymer, etc.), including one or more monomers from the group of vinylidene fluoride (VDF), hexafluoropropylene (HPF), chlorotrifluoroethylene, hydropentafluoropropylene, tetrafluoroethylene (TFE), perfluorovinyl ether, perfluoromethylvinyl ether. In particular, the polymer can comprise or consist of 1,1-dihydroperfluorobutyl acrylate and/or vinylfluoride as the monomer units. The copolymers (ter-, tetrapolymers, etc.) can each represent block polymers, statistic polymers or graft polymers.

The polymer of the cover can include or at least substantially consist of at least one or more copolymers, terpolymers and/or tetrapolymers or higher copolymers, while the various co-, ter- and tetrapolymers can be present also in combination.

One or more of the copolymers vinylidene fluoride (VDF)-hexafluoropropylene (HFP), VDF-chlorotrifluoroethylene, VDF-hydropentafluoropropylene, tetrafluoroethylene (TFE)-propylene, TFE-VDF-copolymers, TFE-VDF, vinylidene fluoride-chlorotrifluoroethylene-copolymer can be mentioned as an example.

The polymer of the cover can include or at least substantially consist of terpolymers of the type VDF-HFP-TFE, VDF-TFE-perfluorovinylether, PFE-perfluoromethylvinyl ether (PMVE)-propylene, VDF-TFE-propylene, VDF-TFE-hydropentafluoropropylene, vinylidene fluoride-tetrafluoroethylene-perfluoromethylvinylether copolymer.

The fluorinated polymer of the cover can further include tetrapolymers or can consist of the same, such as for example VDF-HFP-TFE-PMVE or VDF-HFP-FTE-ethylene.

The fluorinated polymers used in the cover can thus include non-perfluorinated monomer units, for example chlorotrifluoroethylene, hydropentafluoropropylene or ethylene. Alternatively or additionally, the fluorinated polymeric monomer units can include functional ether groups like perfluorovinyl ether and/or perfluoromethylvinyl ether.

The copolymers that are used can have a fluorine content of up to 65 to 65.5% by weight, e.g. a fluorine content of up to 67% by weight (especially with the use of terpolymers) or of up to 67-69% by weight (especially with the use of tetrapolymers). These data respectively refer to the corresponding polymer weight.

If the fluoropolymer of the cover includes vinylflouride and/or vinylidenefluoride monomer units, the moiety of the monomers can respectively be 5-90% by weight, e.g. ≦75% by weight, ≦50 or 30% by weight, in relation to the total weight of the polymer. The vinylfluoride and/or vinylidenefluoride content in the fluoropolymer can be within the range of 5-40% by weight or 10-40% by weight or 10-30% by weight.

Alternatively or additionally to the vinylfluoride and/or vinylidenefluoride content in the fluoropolymer, at least one, two or more monomers of a different unsaturated monomer unit can be included, wherein the monomer respectively contains fluorine, if necessary in addition to a different halogen, such as especially chlorine, and is especially perfluorinated. The unsaturated monomers can be one or more monomers selected from the group of tetrafluoroethylene, trifluoroethylene, trifluorochloroethylene, pentafluoropropylene, pentafluorochloropropylene, hexafluoropropylene. Additionally or alternatively one or more monomers can be selected from the group of fluoropropylvinyl ether, fluoroethylvinyl ether or fluoromethylvinyl ether, each especially as a perfluorocompound, while one or more fluorine atoms can be replaced if necessary also by a different halogen, particularly by chlorine. One or more of the monomers from the above-mentioned two groups can be respectively present individually or totally at a percentage of 5 to 80% by weight, if necessary ≦75 or ≦50 or ≦30% by weight, in relation to 100 parts by weight of the polymer of the cover, for instance within a range of 5-20% by weight or 10-20% by weight.

One, two or three of the copolymers HFP-VDF, TFE-VDF and/or TFE-HFP-VDF can be present in the cover at a content of 10-100% by weight, e.g. 5-90% by weight, preferably ≦80 or ≦75 or ≦50% by weight, each in relation to 100 parts by weight of the fluoropolymer. TFE-VDF, HFP-VDF and/or TFE-HFP-VDF can be respectively included at a percentage of ≧10% by weight or ≧20 or ≧30% by weight, in relation to the polymer of the cover.

The structure of the preferably duromeric fluoropolymer and/or other polymeric components of the cover, preferably the structure of all the polymers, can be free from heteroatoms and particularly free from ether groups, free from O, N and/or Si atoms. The structure of the polymers can each be a virtually pure carbon structure. The fluoropolymer and other polymeric components can be substantially or completely free from side groups that contain functional O, N and/or Si groups, such as ether groups for example, or they can be free from heteroatoms, except of halogen. This respectively refers preferably to non-crosslinked polymer, not taking into account the corresponding cross-linkers or other auxiliary materials. But preferably, the fluoropolymer includes halogenated and particularly perhalogenated alkyl side groups, wherein halogen can be fluorine, especially —CF₃ and C₂F₅ groups, respectively.

Less than 10 or 5%, preferably less than 1% or 2% of the atoms of the fluoropolymer, in each case in relation to 100 carbon atoms of the polymer, can be present as unsaturated groups. Particularly preferably, the fluoropolymer virtually does not include any unsaturated groups.

If necessary, the cover can also include non-fluorinated polymers, e.g. at a percentage of ≦20% by weight, preferably ≦10% by weight, particularly preferably ≦5% by weight, in each case in relation to 100 parts by weight of the polymer.

In a further advantageous embodiment, the fluorinated polymer can be a fluorosilicone resin or a combination of fluorosilicone resins. The alkyl, aryl and/or chloroalkyl groups of these silicone resins are at least partially fluorinated and if necessary perfluorinated with respect to some or all of the monomers that are used. The crosslinking of these resins can take place via trifunctional organosilanes, e.g. organotrichlorosilane or silicon tetrachloride. Alternatively or additionally, the siloxanes can be cross-linked by unsaturated organic groups, in particular unsaturated C-C-groups such as vinyl groups, butadiene radicals or the like. These silicone resins can include or consist of fluorinated polydiorganosiloxanes, in which the organic groups can be partly fluorinated or perfluorinated. Accordingly, the polymeric fluorosilicone components can include polydiorganosiloxanes of the general formula X—O—(SiOₓR¹R²—(SiO)_{y}R³R⁴—X, wherein the radicals R¹ to R⁴ can represent fluorinated or perfluorinated alkyl, aryl or alkenyl radicals and wherein x is a suitable end group, in particular hydrogen, methylphenylvinylsilyl or silyl radicals with C-C unsaturated groups, wherein the polymers can be highly cross-linked via unsaturated C-C groups. Correspondingly, even additional siloxane units —O—(SiO)_{z}R⁵R⁶, etc. can be provided. The alkyl, aryl or unsaturated hydrocarbon groups can each include 1 to 20 carbon atoms, preferably ≧2, or 4 C atoms, if necessary also 2 to 10 or 4 to 6 C atoms. If necessary, the corresponding fluorosilicone homopolymers can each be also vinyl-terminated or terminated by other unsaturated hydrocarbon groups, by which the polymeric strands are cross-linked. The corresponding fluorosilicone polymers can particularly form interpenetrating crosslinks or there can be functionalized polysiloxanes cross-linked with organic fluoropolymers, e.g. fluoropolymers.

In a further advantageous embodiment, the fluorinated polymers are one or more fluorothermoplastics, for example ECTFE (ethylene-chlorotrifluoroethylene copolymers), ETFE (tetrafluoroethylene-ethylene copolymers), FEP (tetrafluoroethylene-hexafluoropropylene copolymers), PFA (tetrafluoroethylene-perfluorovinylether copolymers), PVDF (polyvinylidenefluoride), PVDF copolymers (copolymers with hexafluoropropylene HFP or chlorotrifluoroethylene CTFE), PTFE (polytetrafluoroethylene)/or THV (tetrafluoroethylene-hexafluoropropylene-vinylidenefluoride polymers). The thermoplastics can thus generally include as monomers chlorotrifluoroethylene or other mixed halogenalkane units, tetrafluoroethylene, hexafluoropropylene, perfluorovinylether, polyvinylidenefluoride, without being limited to these. Alkylene units, e.g. ethylene, propylene or butylene, can be provided as monomers. Each of the monomers can be partly halogenated or perhalogenated or fluorinated. Each of the above-mentioned co- or ter-polymers can be statistical polymers, block polymers, graft polymers or the like.

In a further embodiment, the fluorinated polymers that are used can be fluoropolymeric lacquers, which can each represent water or solvent-based lacquers or powder lacquers. The lacquers each contain at least one or more binders and in most cases additionally suitable fillers and additives.

The binders, which are each fluorinated or perfluorinated, can be selected for example from one or more of the group consisting of acrylate resins, aldehyde resins, alkyd resins, amido resins, amino epoxy resins, amino resins, benzoguanamine resins, bitumen resins, cellulose resins, cellulose acetate, cellulose acetobutyrate, cellulose acetopropionate, cellulose nitrate, diamine resins, epoxy acrylates, epoxy resins, epoxy resin esters, epoxy resin/tar combinations, epoxymethacrylate, acetate resins like ethylene/vinylacetate, fluoropolymer resins, formaldehyde resins, including modified resins, urea/formaldehyde resins, urea resins, hydroxyacrylate, indene resins, isocyanate resins, ketone resins, hydrocarbon resins, colophonium resin esters, colophonium resins, maleinate resins, melamine/formaldehyde resins, melamine resins, methacrylates, natural resins, phenol/formaldehyde resins, phenol resins, phenoxy resins, polyacrylates, polyacrylic acid ester, polyamide resins, polyamines, polyaminoamides, saturated and unsaturated polyesters, polyester acrylates, polyether acrylates, polyethylene (also halogenated or chlorinated), polyhydroxy resins, polyisocyanates, polymethylmethacrylates, polymethacrylate, polyolefins (also halogenated or chlorinated), polyol resins, polypropylene, polysiloxane resins, polystyrols, polyurethane resins, polyurethan/tar combinations, polyvinyl resins, polyvinyl acetate, polyvinylbutyral, polyvinylchloride (chlorinated), polyvinylidene chloride, polyvinylidene fluoride, resinates, silanes, silicone resins, siloxane resins, urethane resins.

Preferably, the binder percentage in the lacquer, in relation to the water-free or solvent-free composition, is ≧25-30% by weight, ≧50-55% by weight, preferably ≧60-70%, if necessary ≧75-80% by weight, or even ≧90% by weight.

It will be understood that in each case one or more of the above-mentioned fluorinated polymers can be contained in the cover. Preferably, at least one of the above-described fluorinated polymers forms a continuous matrix of the cover. The cover can respectively extend in the circumferential direction and/or longitudinal direction of the roller over at least approximately the entire extension of the roller. Preferably, the fluorinated polymer forms the cover at least substantially or even completely (in relation to the polymeric components), except for the usual additional materials, such as fillers, additives and/or coloring agents, etc.

The percentage of the polymeric components, particularly of the above-mentioned fluorinated polymers, can be ≧50 to 60% by weight, ≧70 to 75% by weight, ≧80 to 90% by weight, 95 to 98% by weight, or approx. 100% by weight, in relation to the total weight of the polymeric components of the cover or in relation to the total weight of the overall cover.

In addition to fluorine, the cover can also include other halogens, in particular chlorine. The fluorinated polymer of the cover can be perhalogenated or perfluorinated. Preferably, ≧50%, ≧60%, ≧75%, ≧80%, ≧90%, ≧95-85%, or approx. 100% of the H atoms of the cover-forming polymers are replaced by halogen atoms, in particular by fluorine atoms, preferably ≧50%, ≧75 to 80%, ≧90%, or approx. 100% of the halogen atoms of the fluorinated polymer are fluorine atoms (expressed in at. %). Alternatively, also a significant hydrogen content can be present, e.g. as carbon-bound hydrogen. Accordingly, in relation to the sum of the C-bound hydrogen and halogen or fluorine atoms, the percentage of the hydrogen atoms can be ≧0.5-1 at. %, ≧2-4 at. %, ≧7.5-9 at. % or up to 10-11 at. %, or even ≧20-25 at. %.

The fluorine content of the fluoropolymer or of the overall cover can be 60 to approx. 74% by weight, preferably approx. 64 to approx. 72% by weight, e.g., approx. 66 to approx. 70% by weight and in particular approx. 68% by weight.

The respective fluorinated polymer of the cover or the overall cover can each have additional fillers, additives and/or coloring agents, and if necessary further components.

As fillers, there can be provided one or more of the group consisting of aluminum oxides and hydroxides, aluminum silicates, aluminum trihydrates, inorganic oxides, calcium carbonates (naturally or precipitated), carbonates like barium or calcium carbonate, cristobalite, dolomite, fiber materials like glass and mineral wool, graphite, feldspars, fluoropolymer powders (e.g. PTFE and PFA powders), silicates, stratified silicates like mica, framework silicates (the silicates may each contain as cations at least predominantly sodium, potassium, magnesium and/or calcium), hydrogels, kaolin, carbon fibers, silica, silica gels, silica chalk, silicic acid, corundum, magnesium hydroxide, micro hollow spheres, quartz, e.g. in the form of quartz flour, carbon blacks, sand, silicon dioxides, silicate fillers, sulfates like barium or calcium sulfate, super absorbers, talcum, titanium dioxides, wollastonites, without being limited to these.

Optionally, the fillers can be used in a surface-modified, e.g. hydrophobic form. Optionally, the cover can be free of carbon black, silicates, sand and/or quartz. Further, the cover can be free of fiber materials or fibrous components, hollow spheres and/or coarse-particle fillers having a particle size of ≦25 μm or ≦10-20 μm. Preferably, the medium or maximum particle size of the fillers is ≦5-7.5 μm, ≦2-3 μm or particularly preferably ≦1-1.5 μm or ≦0.5-0.75 μm, where appropriate also ≦0.3 μm.

As additives, there can be provided in the polymer or lacquer or generally in the cover one or more of the group consisting of: adsorbants, algicides, antioxidants, anti-runoff agents, anti-settling agents, anti-floating agents, anti-blocking agents, anti-thickening agents, anti-fouling agents, anti-graffiti additives, non-stick agents, anti-skin additives, anti-cratering agents, brighteners (optical), bactericides, dispersing additives, emulsification additives, degasification additives, breathers, defoaming agents, flame inhibitors, fungicides, gelling agents, luster improving agents, lubricating additives, adhesion promoters, hydrophilic agents, hydrophobic agents, catalysts, preserving additives, corrosion inhibitors, conductivity additives, light protecting agents, dulling additives, wetting additives, opentime additives, photo initiators, rheological additives, grindability improving agents, siccatives, soft-feel additives, stabilizers, radiation-hardening additives, substrate wetting additives, thixotropic agents, separating agents, drying agents, UV absorbers, UV stabilizers, thickeners, flow agents, crosslinking agents, viscosity stabilizers, waxes.

As colorants, there can be provided one or more from the group consisting of effect pigments, inorganic and organic coloring pigments, soluble colorants, functional pigments, pigment preparations, black pigments, white pigments.

The filler content of the cover can be ≦75 or ≦45-50% by weight, preferably ≦30-40% by weight, ≦20-25 or ≦19% by weight. Particularly preferably, the filler content of the cover is ≦7.5-10% by weight or ≦4-5% by weight. Particularly preferably, the filler content of the cover is ≦1-2% by weight or the cover is substantially filler-free. These weight specifications relate to the total weight of the polymeric components of the cover or to the weight of the overall cover. This may analogously apply to the composition of the cover, wherein the sum of the additive and colorant content preferably amounts to ≦25% of the cover.

The layer thickness of the cover of the fluorinated polymer can be ≦200 μm, preferably 90-100 μm, particularly preferably ≦70-80 μm or ≦50-60 μm. The layer thickness of the cover can be ≧2-3 μm or ≧5-10 μm, preferably ≧20-30 μm. The layer thickness of the cover can be particularly within a range of 40-70 μm. The cover can be designed homogeneously throughout its thickness, i.e., without gradients concerning a property, such as the crosslinking degree, hardness, content of other components, or the like. The layer thickness is preferably selected so as to enable, as much as possible, a dissipation of heat from the roller surface to the roller core.

The layer thickness of an intermediate layer between the fluoropolymeric cover and the roller core, e.g. an adhesion promoting layer, can be ≦50-70 μm, preferably ≦40-45 μm or ≦30-35 μm, particularly preferably ≦20-25 μm. The layer thickness of the intermediate layer can be ≧2-3 μm or ≧5-7 μm, for example ≧10 μm. The layer thickness of the layer thickness of the intermediate layer can be generally smaller than that of the fluoropolymeric cover.

The layer thickness of the overall cover consisting of the fluoropolymeric cover and the intermediate layer can be ≦200 μm, preferably ≦180-150 μm, particularly preferably ≦120-100 μm, or even ≦75-90 μm.

Preferably, the fluoropolymeric cover can be applied on the rigid, non-deformable roller core directly or, if necessary, via an intermediate layer, particularly via an adhesion promoting layer, whose thickness is preferably smaller than that of the cover. The roller core can consist of a metal. The intermediate layer preferably includes no fiber components and/or fillers. Preferably, in one embodiment, no further intermediate layer is provided in addition to the adhesion promoting layer between the fluoropolymeric cover and the roller core.

If the roller of the invention comprises a hard-elastic intermediate layer, the layer thickness of the same is preferably equal to or greater than that of the cover having a hardness of ≧15 Shore D, but if necessary, it can be smaller. The layer thickness of the intermediate layer can be up to 100 μm or up to 200-300 μm or up to 500 μm, up to 1-2 mm or up to 5 mm or more. If necessary, the layer thickness of the intermediate layer can also be smaller than that of the cover. Such an intermediate layer downgrades the heat transfer from the roller surface to the roller core, which is mostly undesired, but it can be provided if an optimum heat transfer is not necessarily required and if other properties of the roller cover are to be optimized as a whole. The hard-elastic intermediate layer can have a hardness within the Shore D range, e.g. ≧10-15 Shore D or ≧20 Shore D.

The hardness of the hard-elastic intermediate layer can be ≧10-15 Shore D, e.g. even ≧20-30 Shore D; preferably the hardness is ≦50-60 Shore D or ≦70-80 Shore D. The hardness of the hard-elastic intermediate layer can be within a range of 30-40 Shore D. The hardness of the hard-elastic intermediate layer is preferably lower than the hardness of the fluoropolymeric cover applied to it. If necessary, it can also be approximately equal to the same, with a relative fluctuation of e.g. ≦±15-20% or ≦±5-10%. In this context, the expression “hard-elastic” can also be understood to mean “duromer-elastic” or “energy-elastic,” so that the intermediate layer accordingly is “not entropy-elastic.”

The cover, which is provided near or on the roller surface, preferably extends over at least approximately the entire width of the effective area which is active during the printing process, e.g. the effective area which is active during the operation of the distributor or which serves as a transfer surface for the printing medium. Preferably, the fluoropolymeric cover extends over the full circumference of the roller.

The invention also relates to a printing machine comprising at least one or more rollers of the invention. Preferably, all distributor rollers and/or all transfer rollers are designed with a cover having a hardness of ≧15 Shore D to form rollers according to the invention. The rollers of the invention can be additionally provided in the cleaning unit of the respective inking unit or in the printing machine, but preferably they are arranged in the inking unit of the printing machine.

Preferably, the rollers of the invention in the respective printing machine or in the inking unit counteract at least one or more rollers equipped with a cover made of a polymeric material of a lower hardness. These rollers can be also provided with a highly hydrophobic cover, particularly with an elastic fluoropolymer or with a cover which includes such elastic fluoropolymers, especially as the matrix material of the cover. Such rollers are known from German patent document DE 10 2004 054 425, the contents of which are incorporated herein by reference. The covers of these rollers normally have a hardness of ≧20 Shore A and ≦80 Shore A, at least a hardness within a range of 20 to 50 Shore A.

Accordingly, it is decisive in the present invention that the surface tension of the hard rollers of the invention (preferably the rollers having a duromeric or thermoplastic cover) exhibit approximately the same low surface tension as soft rollers (the rollers having an elastomeric cover) of the inking unit, which can be coated in particular with an elastic fluoropolymer, such as a fluororubber. The surface tension of the counteracting rollers of the invention and of the soft rollers can thus respectively be ≦40-50 mN/m, preferably ≦25-30 mN/m or ≦15-20 mN/m. The relative difference of the surfaces tensions of the rollers of the invention and of the soft-elastic counter rollers can be ≦75-100%, preferably ≦30-50% or ≦20-25% and particularly preferably ≦15-10%. All elements of the inking unit can thus be equipped with a compatible and almost equally low surface tension.

Preferably, the cover of the roller of the invention almost completely consists of the described fluorinated polymers, except for possible fillers, additives and/or colorants or other auxiliary agents.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic illustration of a printing machine having distributor and transfer rollers designed according to embodiments of the invention.

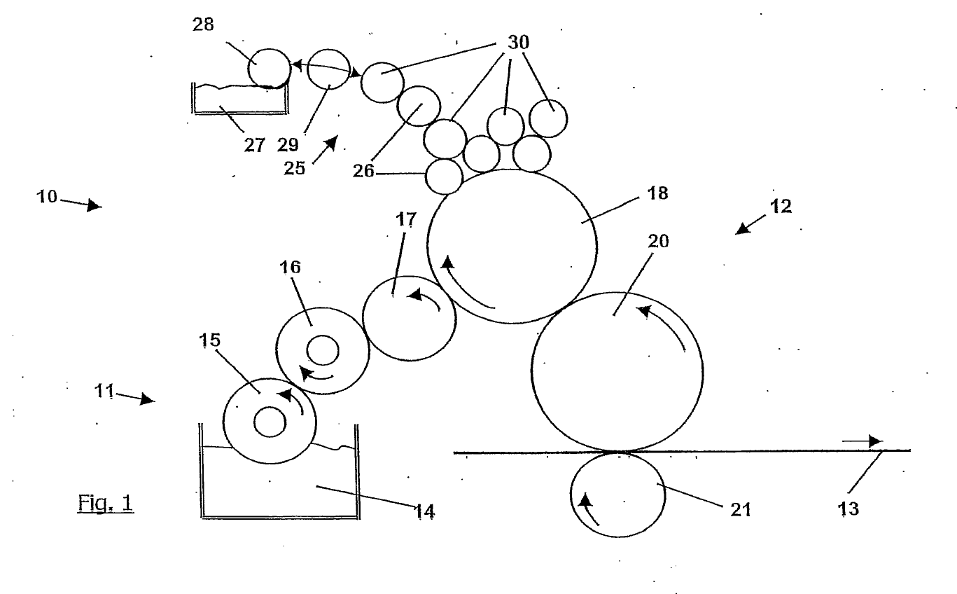

### DETAILED DESCRIPTION OF THE INVENTION

In a first embodiment, the distributor roller includes a cover that is applied on a rigid core, e.g. a steel core, by an adhesion promoting layer. The cover has a layer thickness of 80 μm and a hardness of 50 Shore D. The cover consists of a fluorinated polymer in the form a duroplastic, which can be a polyurethane resin, polyester resin, epoxy resin, acrylate, or polyether resin. 95% of the carbon-bound hydrogen atoms of the polymer are substituted by fluorine atoms. There are 30 covalent crosslink positions in relation to 100 monomers of the polymeric material.

A second embodiment is concerned with a roller according to the first embodiment, the cover in this second embodiment being applied on a hard-elastic intermediate layer made of hard rubber, which has a layer thickness of 500μ and a hardness of 20 Shore D. Such a roller is particularly suitable for use as a transfer roller in a printing machine.

In a third embodiment, a distributor roller comprises a cover which is applied by an adhesion promoting layer on a rigid roller core and which has a layer thickness of 60 to 80 μm and a hardness of 55 Shore D. The cover consists of a highly cross-linked PFE-PMVE-propylene terpolymer, and there are approx. 30 crosslink positions in relation to 100 monomer units. The fluorine content of the cover is 65% by weight in relation to the polymer weight. The cover can be particularly applied on the roller core in the form of an aqueous dispersion or a solution with organic solvents.

The fourth embodiment is a modification of the third embodiment, wherein between the roller core and the cover, a hard-elastic intermediate layer having a layer thickness of 200 μm and a hardness of 30 Shore D is applied.

In a further embodiment, a cover made of a highly cross-linked fluorosilicone polymer having a layer thickness of 50 μm and a hardness of 40 Shore D is applied on a rigid core. The C6-C12 alkyl-substitutes of the silicon polymer are each perfluorinated. The silicon polymer is three-dimensionally cross-linked via unsaturated side groups, particularly vinyl groups and/or trifunctional Si atoms. Optionally, the cover can be applied on a hard-elastic intermediate layer made of hard rubber, which has a layer thickness of approx. 1 mm and a hardness of approx. 35 Shore D.

In a further embodiment, the roller, which is preferably suitable for use as a distributor roller, comprises a cover which is directly applied in a suitable manner on the roller core. The cover consists of a fluorothermoplastic, e.g. ECTFE or PVDF and has a layer thickness of approx. 50μ and a hardness of approx. 40 Shore D.

The covers according to the embodiments can each include fillers and further additives, wherein the fillers can be provided at an amount of up to 10-40% by weight in relation to the total weight of the cover material, without being limited thereto. But the cover can respectively also be filler-free. Furthermore, the covers can comprise usual additives, which can be present at a percentage of up to 15-25% by weight in relation to the total weight of the cover material, without being limited thereto.

If in the rollers according to the embodiments the cover is directly applied on the roller core—if necessary by an adhesion promoting layer, these rollers particularly preferably represent distributor rollers, which can be provided with a cooling device. If a hard-elastic intermediate layer is provided between the roller core and the cover, these rollers can be particularly preferably used as transfer rollers, which may counteract the transfer rollers covered with an elastic material. Optionally, these rollers can be also used as distributor rollers.

The invention also relates to a printing machine comprising a roller according to the invention. The roller of the invention can counteract at least one counter roller having a cover made of an elastic, polymeric material having a lower hardness. The elastic, polymeric material of the counter roller can be a fluoroelastomer or the cover of the counter roller can include such a fluoroelastomer. The distributor or transfer roller of the invention can be a component of the inking unit. The roller of the invention can also be used in the dry offset.

The printing machine 10 (in particular an offset printing machine) comprises a dampening unit 11 and a printing unit 12 for printing a print substrate, such as a paper web. The dampening unit 11 comprises a dampening medium reservoir 14, from which a dampening medium like water admixed with auxiliary materials is conveyed using an immersion roller. The conveyed amount of dampening medium is measured out by a metering roller 16 counteracting the immersion roller 15. The dampening medium film thus produced is subsequently transferred to at least one dampening applicator roller 17 and thereafter from the dampening unit 11 to the plate cylinder 18 (also referred to as printing plate cylinder) of the printing unit 12. Of course, instead of the plate cylinder a printing plate can be used in a corresponding manner, which is capable of directly printing the respective object, if necessary. To the plate cylinder 18 a printing ink or generally a printing medium is applied by the rollers 26 of an inking unit 25. The printing medium from the reservoir 27 is conveyed by a duct roller 28 or any other conveying means and is transferred to a distributor roller 30 using a mostly elastomer-coated lifting roller 29. The lifting roller 29 is oscillated to and fro between the duct roller 28 and the distributor roller 30. A part of or all the distributor rollers can be designed in accordance with the invention, for example in accordance with the above-mentioned embodiments. The distributor rollers 30 can be partly designed as non-oscillating transfer rollers. A part or all of the rollers 26 can be soft-elastically coated. Between the downstream inking rollers 26 and the distributor rollers 30 a homogeneous printing medium film having a desired thickness is produced respectively, which is transferred to the plate cylinder 18.

It will be appreciated that the inking unit 25 can be alternatively designed as a film inking unit, in which the duct roller is raked and does not directly touch a non-elastomerically coated film roller running at machine speed.

The rollers of the invention, which are designed as distributor rollers, are generally moved in a traversing fashion, i.e. oscillating in the roller longitudinal direction, and counteract transfer rollers, which are preferably elastically coated. The distributor rollers of the invention can each be provided with a cooling device. In this case, the distributor rollers are permanently fixed for replacement in the printing unit, because the distributor rollers have a very high service life. The transfer rollers used in the invention do not perform a traversing movement.

Usually, the print image, that is produced on the plate cylinder 18 by more hydrophilic and more hydrophobic parts on the printing cylinder, is then transferred via the rubber blanket cylinder 20 onto the printing substrate 13, which is passed between the rubber blanket cylinder 20 and a counter pressure cylinder 21.

Accordingly, in the inking unit of a printing machine there is generally provided a printing medium reservoir from which printing medium is conveyed by a suitable device and is supplied to the inking unit by a lifting roller or any other transferring device. Via the rollers of the inking unit, which comprise elastically coated transfer rollers, inventive hard transfer rollers and distributor rollers, the printing medium is then transferred to a printing plate cylinder or to any other printing plate that comprises hydrophilic and hydrophobic surface parts for producing a corresponding image, and thereafter for the most part from the printing plate cylinder via a rubber blanket cylinder to an object to be printed, for example a paper layer. Thus, the distributor and transfer rollers of the invention are preferably arranged between the lifting roller and the printing plate cylinder or the printing plate. The distributor or transfer roller of the invention can counteract one or more rollers that are provided with an elastic cover. Optionally, the inking and dampening units can also be designed in combination, so that the plate cylinder 18 is supplied with an inking-dampening-emulsion in accordance with the conditions. But the roller of the invention is particularly suitable also for use in waterless offset printing, preferably in offset machines without a dampening unit.

According to the embodiment, the rollers of the invention can have a cover with a coating of ≧15 Shore D hardness. These rollers can counteract elastically coated rollers whose surface cover can have a hardness of, for example, 20 to 60 Shore A, for instance 30 Shore A. The cover can consist of a base polymer in the form of a highly cross-linked, non-elastic (non-entropyelastic) fluoropolymer in addition to fillers and other usual components, or it can contain such a polymer for more than 50% by weight in relation to the polymer content or the total weight of the cover. The roller or roller cover can have a surface roughness of ≦3 μm Rz. The fluorinated polymer can have 10 to 20 crosslink positions in relation to the polymer base structure with a carbon number corresponding to 100 C4-C8 monomers and can include, for instance, a fluorinated polyurethane resin, polyester resin, epoxy resin, acrylate resin, polycarbonate or polyether resin. The fluoropolymer can include as copolymers vinylidene fluoride and hydropentafluoropropylene monomer units. Alternatively, the fluoropolymer forming the cover can be a fluorothermoplastic and contain, for example, ECTFE, FEP, PVDF and/or THV. According to a further alternative, the fluorinated polymer can also be a fluoropolymer lacquer. The fluorinated polymer can be perfluorinated respectively, without being limited thereto. The filler content of the cover can amount to approx. 20% by weight in relation to the total weight of the cover material. The layer thickness of the cover can be approx. 40 μm. Between the cover and the roller core a hard rubber intermediate layer can be provided whose hardness is smaller than or equal to the hardness of the fluoropolymeric cover.

The above-described cover or a different cover according to the invention can be a fluoropolymeric cover having a scratch hardness of 6B or higher, according to ISO 15184:1998(E), for example a scratch hardness of ≧4B, ≧2B or ≧B or higher, e.g. a scratch hardness of ≧F or ≧H, particularly preferably a scratch hardness of ≧2H or ≧4H.

The scratch test for each case can be carried out at room temperature (22° C.) and at a relative humidity of 50%. For determining the scratch hardness stated herein, an Elcometer 501 Pencil Hardness tester can be used. The scratch hardness can be determined using pencils of the type Faber-Castell 9000 Design Set (pencil hardness 6B-6H). These conditions can apply for all data concerning the invention. The stated pencil hardness (scratch hardness) thus corresponds to the respective hardest pencil with which a corresponding scratch mark cannot yet be recognized, for instance optically by inspection or by manual palpation.

It is accepted within the scope of the invention, as has been determined by the experimental tests performed on the covers of the invention, that a scratch which is yet visible has a depth of 1 μm, but is no longer manually palpable. Scratches or score marks having a depth less than 0.5 μm, which can represent a plastic deformation of the cover material, cannot be measured anymore by the testing instruments used in the invention and can neither be recognized anymore by the human eye even at the angle of incidence. Within the scope of the invention, measuring the scratch depth was carried out by casting the scratch using suitable plasters such as “Mikrosil” plasters which thereafter were measured for their profile height under the surface palpator for the profile method according to DIN ISO 4288.1989, e.g. by using an instrument of the type “Waveline” from the company of Hommelwerke. Alternatively, for the determination of the profile height, a strip triangulation measuring device for the structural analysis of surfaces like the ODSCAD device from the company of GF Messtechnik (see parameters of the GMF evaluation of tables in Examples 1 and 2 below) or White Light interferometer can be used. On the basis of the examinations it could be determined that at the scratch hardness of the roll cover respectively stated herein within the scope of the invention, the scores produced by the scratch test (and no longer recognizable) have a depth of ≦0.5 μm, if present, which applies to coatings having a surface hardness Rz of ≦2 μm.

The respective scratch hardness within the scope of the invention relates to surfaces having a roughness Rz of 2-3 μm, particularly approx. 2 μm or smaller, if not otherwise stated. Should the roughness of a cover to be examined be higher than approx. 2-3 μm, the same should be smoothed by appropriate means before carrying out the scratch test, for example by polishing, to achieve the stated roughness value Rz of 2-3 μm, particularly approx. 2 μm, in order to deliver comparable results.

The visible scratches each produced typically have a width of 200-300 μm or more, particularly in the case of deeper scratches.

The measuring values were each determined on a plate/metal sheet provided with the cover material and at thickness of the cover of approx. 40 μm. But these values apply analogously, if the scratch tests are carried out on a roller correspondingly coated with the cover.

Generally within the scope of the invention, the cover material can be applied to the roller core, for example from a liquid phase, and the roller core can be prepared by an adhesion promoter. If necessary, a hard intermediate layer can be applied first on the core, if necessary also by using an adhesion promoter, and an adhesion promoter is then applied on the hard intermediate layer and thereafter the cover material from liquid phase as a coating, by using suitable methods, so that the cover has a layer thickness in the order of 15 to 50 μm, if not otherwise stated.

The sample metal sheets for carrying out the scratch tests were sandblasted sheets having an Rz smaller than 15 μm. The sheets were then spray-coated with 15 μm of a suitable liquid phase adhesion promoter and then, after half an hour of intermediate drying at 40° C., with approx. 25 μm of the functional coating (cover) made of fluorocarbon resin, also by spraying this time in two steps, and cross-linked for four hours at 140° C. after two hours of drying at room temperature. The resulting roughness of the cover surface is above all a result of the spray and application parameters. The drier the aerosol is during coating the rougher is the coating which is produced. The test is then carried out after 24 hours of storage under normal climate.

### Example 1

Example 1 relates to a first inventive roller cover having a surface roughness of the intact surface of 1.4 μm (Rz). A steel sheet surface serves as a substrate coated with fluorohydrocarbon resin, as the material of the roller cover.

| Pencil | | GFM evaluation |
|---|---|---|
| hardness | Visual/Manual Observation of Scratch | depth [μm] |
| 4B | not visible | not measured |
| 3B | support point of pencil minimally visible | measurement not evaluable |
| 2B | visible scratch, | ~1.3 |
| | not palpable | |
| B | visible scratch, | ~1.8 |
| | palpable | |
| HB | visible scratch, | ~2.5 |
| | palpable | |
| F | visible scratch, | ~2.6 |
| | palpable (top coat initially scratched) | |
| H | visible scratch, palpable | ~2.25 |
| | (punctiform destruction of the surface down to the | |
| | metal) | |
| 2H | visible scratch, palpable | ~4.6 |
| | (1 mm long destruction of the surface down to the metal) | |
| 3H | 12 mm long destruction of the surface down to the | ~20.0 |
| | primer layer, punctiform destruction of the surface down | |
| | to the metal | |
| 4H | 14 mm long destruction of the surface down to the | ~16.0 |
| | primer layer, punctiform destruction of the surface down | |
| | to the metal | |

### Example 2

Example 2 shows a determination of the scratch hardness according to Wolff-Willborn on a further embodiment. The surface roughness of the intact surface in this case was 5 μm (Rz). The substrate was a steel sheet coated with a fluorohydrocarbon resin (material of the roller cover). The thickness of the examined cover layer was 40 μm. Rz value of the intact surface: 4.95 μm.

| Pencil | | GFM evaluation |
|---|---|---|
| hardness | Visual/Manual Observation of Scratch | depth [μm] |
| 2B | invisible | not measured |
| B | invisible | not measured |
| HB | invisible | measurement not evaluable |
| F | punctiform destruction of the top coat down to the | ~40 |
| | metal | |
| H | punctiform destruction of the top coat down to the | ~40 |
| | metal | |
| 2H | punctiform destruction of the top coat down to the | ~35 |
| | metal | |
| 3H | punctiform destruction | ~45 |
| | (1.33 mm)of the top coat down to the metal and visible | |
| | scratch, not palpable | |
| 4H | punctiform destruction | ~49 |
| | (1.14 mm)of the top coat down to the metal and visible | |
| | scratch, not palpable | |
| 5H | destruction (1.15 and 2.11 mm) of the top coat down to | ~36 |
| | the metal | |
| 6H | destruction (2.83 and 3.08 mm) of the top coat down to | ~34 |
| | the metal | |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-22. (canceled)

23. A distributor or transfer roller for printing machines, particularly offset printing machines, the roller comprising a substantially rigid core and a permanently fixed cover made of polymeric material applied on the core, the cover being directly applied on the core or on a hard-elastic intermediate layer having a hardness of ≧10 Shore D, wherein the cover comprises at least predominantly or substantially a fluorinated polymer, and wherein the cover has at least one of a hardness of ≧15 Shore D and a scratch hardness according to ISO 15184 of 6B or harder.

24. The roller according to claim 23, wherein the fluorinated polymer is a duroplastic or energy-elastic material.

25. The roller according to claim 23, wherein a surface of the roller cover has a surface energy of ≦25 mN/m.

26. The roller according to claim 23, wherein the cover has a scratch hardness of 4B or higher.

27. The roller according to claim 23, wherein the hardness of the cover is within a range of 25 to 80 Shore D.

28. The roller according to claim 23, wherein the roller has a surface roughness of ≦15 μm Rz.

29. The roller according to claim 23, wherein the fluorinated polymer includes more than 10 crosslink points in relation to the polymer basic structure with a carbon number corresponding to 100 C4-C8 monomers.

30. The roller according to claim 23, wherein the fluorinated polymer comprises at least one fluorinated resin selected from the group consisting of polyurethane resin, polyester resin, epoxy resin, acrylate resin, polycarbonate and polyether resin.

31. The roller according to claim 23, wherein the fluorinated polymer is a highly cross-linked non-elastic (non-entropyelastic) fluoropolymer.

32. The roller according to claim 31, wherein the fluoropolymer is a copolymer, including a terpolymer or tetrapolymer, which contains vinylidene fluoride, hexafluoropropylene, chlorotrifluorethylene, hydropentafluoropropylene, tetrafluoroethylene, perfluorovinyl ether, perfluoromethylvinyl ether, or ethylene monomer units or a combination thereof.

33. The roller according to claim 23, wherein the fluorinated polymer comprises polymeric, non-elastic fluorosilicone units.

34. The roller according to claim 31, wherein the fluorinated polymer comprises a comprises polymeric, non-elastic fluorosilicone units.

35. The roller according to claim 23, wherein the fluorinated polymer is a fluorothermoplastic.

36. The roller according to claim 35, wherein the fluorothermoplastic contains at least one polymer selected from ECTFE, ETFE, FEP, PFA, PVDF, PTFE, THV, and combinations thereof.

37. The roller according to claim 23, wherein the fluorinated polymer is a fluoropolymer lacquer.

38. The roller according to claim 23, wherein the fluorinated polymer has a fluorine content such that ≧50 atomic percent of the hydrogen atoms of the polymer are replaced by fluorine atoms.

39. The roller according to claim 23, wherein the cover comprises a material having a filler content of ≦75% by weight in relation to a total weight of the cover material.

40. The roller according to claim 23, wherein the cover has a layer thickness of ≦200 μm.

41. The roller according to claim 40, wherein the layer thickness of the cover is ≦80 μm.

42. The roller according to claim 23, wherein the hard-elastic intermediate layer has a hardness within a range of 20 to 50 Shore D.

43. The roller according to claim 23, wherein the intermediate layer has at least one of a hardness not greater than the hardness of the fluorinated polymer cover and an elasticity at least as great as the elasticity of the fluorinated polymer cover.

44. The roller according to claim 23, wherein the hard-elastic intermediate layer comprises hard rubber.

45. The roller according to claim 23, wherein the cover is applied to the core or to the intermediate layer by an adhesion promoting layer.

46. A printing machine comprising at least one roller according to claim 23.
